(19) United States
(12) Patent Application Publication
(10) Pub. No.: US 2012/0109820 A1
(43) Pub. Date: May 3, 2012

(54) Computer-Implemented Methods, Computer Program Products, and Systems for Enhanced Loan Product Repayments

(76) Inventors: Scott Galit, New York, NY (US); Trent Sorbe, Brookings, SD (US)

(21) Appl. No.: 13/287,725

(22) Filed: Nov. 2, 2011

Related U.S. Application Data
(63) Continuation of application No. 12/889,281, filed on Sep. 23, 2010.
(60) Provisional application No. 61/245,095, filed on Sep. 23, 2009.

(51) Int. Cl. G06Q 40/02

(52) U.S. Cl. 705/41

(57) ABSTRACT

A computer configured and programmed as a financial institution computer, method, and system to schedule and obtain loan repayments from a customer, including flexible loan repayment mechanisms and schedules corresponding to expected deposit dates, e.g., multiple paydays. The computer can determine a repayment schedule for one or more loans responsive to an electronic loan request by the customer, direct deposit data for the customer, and preselected loan product parameters. The computer can monitor an account for an expected direct deposit from a first time prior to an expectation date of the expected direct deposit and up to a second time after the expectation date for the expected direct deposit to thereby define a time period around the expected direct deposit. The computer can obtain one or more repayments responsive to a receipt of the expected direct deposit, the expected direct deposit being one of a predetermined hierarchy of deposit sources.

This application is a continuation and claims priority and benefit to U.S. patent application Ser. No. 12/889,281, by Galit, et al., titled “Computer-Implemented Methods, Computer Program Products, and Systems for Enhanced Loan Product Repayments” filed on Sep. 23, 2010, which claims priority and benefit to U.S. Provisional Patent Application No. 61/245,095, by Galit et al., titled “Computer-Implemented Methods, Program Products, and Systems for Enhanced Loan Product Repayments” filed on Sep. 23, 2009, all and each of which are incorporated herein by reference in their entireties. This application also relates to: U.S. patent application Ser. No. 12/338,365, by Sorbe et al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,402, by Sorbe of al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,440, by Sorbe et al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008, which claims priority to U.S. Provisional Patent Application Nos. 61/016,213 and 61/052,454; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008, which claims priority to U.S. Provisional Patent Application Nos. 61/016,213 and 61/052,454; U.S. patent application Ser. No. 12/389,749, by Sorbe et al., titled “Methods to Advance Loan Proceeds on Prepaid Cards, Associated Systems and Computer Program Products” filed on Feb. 20, 2009, which claims priority to U.S. Provisional Patent Application No. 61/029,975; U.S. patent application Ser. No. 12/417,199, by Ahlers et al., titled “System, Program Product, and Associated Methods to Authorize Draw for Micro-Credit Attached to a Prepaid Card” filed Apr. 2, 2009, which claims priority to U.S. Provisional Patent Application No. 61/042,612; U.S. patent application Ser. No. 12/417,211, by Ahlers et al., titled “System, Program Product, and Associated Methods to Authorize Draw for Micro-Credit Attached to a Prepaid Card” filed Apr. 2, 2009, which claims priority to U.S. Provisional Patent Application No. 61/042,612; U.S. patent application Ser. No. 12/338,684, by Ahlers et al., titled “Computer-Implemented Methods, Program Product, and System for Micro-Loan Management” filed on Dec. 18, 2008, which claims priority to U.S. Provisional Patent Application Nos. 61/016,213, 61/052,454, 61/042,612, 61/042,624, 61/032,750, 61/082,863, 61/053,056 and 61/029,975; U.S. patent application Ser. No. 12/338,712, by Galit et al., titled “Computer-Implemented Methods, Program Product, and System to Enhance Banking Terms Over Time” filed on Dec. 18, 2008, which claims priority to U.S. Provisional Patent Application Nos. 61/016,213, 61/060,559, 61/052,454, 61/029,975, 61/042,612, 61/042,624, 61/032,750, 61/082,863, and 61/053,056; U.S. patent application Ser. No. 12/417,162, by Ahlers et al., titled “System, Program Product, and Method For Debit Card and Checking Account Autodraw” filed on the Apr. 2, 2009, which claims priority to U.S. Provisional Patent Application Nos. 61/042,624, 61/060,559, 61/052,454, 61/082,863 and 61/042,612; U.S. patent application Ser. No. 12/465,277, by Galit et al., titled “System, Program Product, and Computer-Implemented Method for Loading a Loan on a Pre-Paid Card” filed May 13, 2009, which claims priority to U.S. Provisional Patent Application Nos. 61/053,056 and 61/060,559; U.S. patent application Ser. No. 12/465,306, by Galit et al., titled “System, Program Product, and Computer-Implemented Method for Loading a Loan on an Existing Pre-Paid Card”. filed May 13, 2009, which claims priority to U.S. Provisional Patent Application Nos. 61/053,056, 61/060,559 and 61/082,863; U.S. patent application Ser. No. 12/465,803, by Galit et al., titled “A Pre-Paid Card Transaction Computer to Load a Loan, on a Pre-Paid Card” filed May 14, 2009, which claims priority to U.S. Provisional Patent Application No. 61/053,056, all and each of which are incorporated herein by reference in their entireties.

### BACKGROUND

1. Field of Invention

The present invention relates generally to the financial service and banking industries, and, more particularly, to systems, computer program products, and associated computer-implemented methods for providing enhanced loan products.

2. Background

It is known that tens of millions of consumers in the United States have either limited or no access to traditional credit, either as a result of poor or limited credit history. It is further known that millions of prepaid cards are issued each year in the United States. It is also known that many of the consumers with limited or no access to traditional credit rely primarily on cash, a prepaid card account, or both for their personal finances; these consumers, for example, may not have a traditional checking, savings, or other bank deposit accounts, and they may not write checks. It has been acknowledged by many that such consumers may be underserved. These consumers are typically not easily able to access credit through traditional banking channels, though they may have an ongoing relationship with a prepaid card issuer, for example.

It is recognized that short-term lending is a $20 billion plus per year industry, and some industry experts believe an appropriate manner of offering micro-lending may be through a federal bank, especially to those underserved, such as those who may or may not have a checking account or other bank deposit account. Yet there can be many obstacles to those being underserved to using a federal bank or any bank for that matter, based on, for example, lack of effective bank products, risks associated with bank products, use of credit bureau scores, i.e., FICO scores, to determine credit availability, and costs to those being underserved does not, or is not perceived to, outweigh the benefits for use of existing bank products.

Payday loans are known. A payday loan typically provides a customer with an unsecured, short-term cash advance until an anticipated payment, i.e., the next payday or benefit disbursement. Customers can utilize payday advances to cover small or unexpected expenses while avoiding costly bounced-check fees and late payment penalties. To acquire a payday loan, a customer often must appear at a retail location to receive the proceeds, typically in cash.

It is known that most commonly-used loan and credit products, not including payday loans but including credit cards, require repayments on a fixed schedule, typically monthly. It is also known that most customers are paid frequently than monthly, e.g., weekly, biweekly, or semimonthly.

As described in U.S. patent application Ser. No. 12/338,684, titled “Computer-Implemented Methods, Program Product, and System for Micro-Loan Management” filed on Dec. 18, 2008, and U.S. patent application Ser. No. 12/338,712, titled “Computer-Implemented Methods, Program Product, and System to Enhance Banking Terms Over Time” filed on Dec. 18, 2008, each incorporated herein by reference in their entirety, Applicants have previously provided introductory and enhanced micro-lending and line of credit products to those underserved by traditional bank products.

### SUMMARY OF INVENTION

In view of the foregoing, Applicants have recognized a need for enhanced lending options and bank products, e.g., prepaid card products, for consumers with access to and experience with micro-lending and non-traditional line of credit bank products, including through a prepaid card account or a similar program. Accordingly, the embodiments of the present invention provides machines, computer program products, and associated computer-implemented methods for enhanced loan repayments.

The embodiments of the present invention provide, for example, a machine to schedule and obtain flexible loan repayments. The machine includes an input/output (“I/O”) interface for communicating with a customer and to interact with a account (e.g., prepaid card account) associated with the customer and a prepaid card processor across a communications network. The machine can include a non-transitory computer memory with a computer program product stored thereon as described herein.

The computer program product, according to an embodiment of the present invention, is stored in a non-transitory computer memory and operable on a machine for performing a process of determining a repayment schedule for one or more loans and the process of obtaining one or more loan repayments pursuant to a repayment schedule. The computer program product when executed by the computer, causes the computer to perform various operations. The operations can include, for example, establishing for a customer a prepaid card account with a financial institution. The operations can include receiving an electronic loan request from the customer for one or more loans, and determining a repayment schedule for the one or more loans responsive to receiving the electronic loan request, direct deposit data for the customer, and preselected loan product parameters. The operations can include establishing a line of credit associated with the prepaid card account with the financial institution, the line of credit having an adjustable credit limit, and wherein the one or more loans are extended from the line of credit. The operations can include advancing one or more loan proceeds to the prepaid card account associated with the customer to make the loan proceeds immediately available. The operations can include monitoring the prepaid card account for an expected direct deposit (e.g., a payroll deposit) from a first time prior to an expectation date for the direct deposit and up to a second time after the expectation date for the direct deposit to thereby define a time period around the expected direct deposit. The operations can include obtaining the one or more repayments responsive to a receipt of the expected direct deposit, the expected direct deposit being one of a predetermined hierarchy of deposit sources, the predetermined hierarchy of deposit sources excluding preselected deposit sources.

An embodiment of the present invention can include, for example, determining a repayment schedule that provides a minimum period before any repayment is due. For example, if an expected deposit date (i.e., payday) is every Friday and the minimum period before any repayment is one day, then a loan advanced on Thursday is, in this example embodiment, within the minimum period so that the first repayment is due the following Friday (eight days after the advance), and not the immediate Friday (one day after the advance). In this example embodiment, a loan advanced on Wednesday is after the minimum period so that the first.

Embodiments of the present invention can include, for example, a computer-implemented method to cause a computer configured as a financial institution computer to perform a process of advancing one or more loans to a prepaid card account and a process of obtaining one or more loan repayments pursuant to a repayment schedule. The computer-implemented method can include, for example, establishing a line of credit associated with a prepaid card account, the line of credit having an adjustable credit limit. The computer-implemented method can include, for example, receiving from the customer an electronic loan request for one or more loans and wherein the one or more loans can be extended from the line of credit. The computer-implemented method can include, for example, determining a repayment schedule by the financial institution computer responsive to receiving the electronic loan request, direct deposit data for the customer, and preselected product parameters. The computer-implemented method can include, for example, monitoring the prepaid card account for an expected direct deposit from a first time prior to an expectation date of the expected direct deposit and up to a second time after the expectation date for the expected direct deposit to thereby define a time period around the expected direct deposit. The computer-implemented method can include, for example, obtaining one or more repayments responsive to a receipt of the expected direct deposit, the expected direct deposit being one of a predetermined hierarchy of deposit sources, the predetermined hierarchy of deposit sources excluding preselected deposit sources. The predetermined hierarchy of deposit sources can exclude preselected deposit sources, such as, for example, child support payments.

Embodiments of the present invention advantageously, for example, provide a larger loan amount than a single-repayment loan, such as a payday loan. In particular, scheduling multiple repayments can allow for a loan amount greater than an anticipated deposit. For example, if an expected paycheck (including an electronic deposit) will be $500, a traditional single-repayment payday loan may be limited to $500, or even less, so that the lender can be assured of repayment on the payday. In contrast, embodiments of the present invention can include loans in amounts of, for example, 75% to 150% of an average reoccurring direct deposit amount. Embodiments of the present invention, for example, can reward responsible behavior by a customer with more favorable loan terms over time. The present invention provides embodiments of systems, program products, and associated computer-implemented methods for micro-loans, including through and by use of prepaid cards, and bank product management and enhanced lending options for both banks and bank customers, as well as other financial institutions.

Features and benefits of the embodiments of the present invention can also advantageously provide the ability for customers to graduate to betters terms over time through demonstrated repayment performance, as opposed to other measurements that may have less to do credit worthiness than repayment, such as, for example, income level. For example, a consumer can graduate from a single-repayment loan program to a multiple-repayment loan program and, once in a multiple-repayment program, can increase a line of credit amount, as well as improve terms and conditions, resulting in lower fees or interest rates for the customer.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1. is a front plan view of a display screen of a computer displaying an excerpt of a credit card account activity statement according to the prior art;

FIG. 2 is a front plan view of a display screen of a computer displaying an excerpt of an account activity statement associated with a line of credit according to an embodiment of the present invention;

FIGS. 3A and 3B are respective front and back plan views of a prepaid card according to an embodiment of the present invention;

FIG. 4 is a schematic block diagram of a machine, configured as a financial institution computer, to provide a loan pursuant to a line of credit according to an embodiment of the present invention;

FIG. 5 is a flow diagram of a hierarchy of deposit sources for repayment according to an embodiment of the present invention;

FIG. 6 is a schematic block diagram of a system to provide a loan pursuant to a line of credit according to an embodiment of the present invention;

FIG. 7 is a schematic diagram of a computer server having program product stored in memory thereof according to an embodiment of the present invention;

FIG. 8 is a schematic flow diagram of a computer-implemented method of providing a loan pursuant to a line of credit according to an embodiment of the present invention;

FIG. 9 is a logic diagram of loan repayment pursuant to a line of credit according to an embodiment of the present invention;

FIG. 10 is a front plan view of an embodiment of an access interface of a program product and system in the form of a graphical user interface of a display of a computer according to an embodiment of the present invention;

FIG. 11 is a partial schematic diagram of a computer program product according to an embodiment of the present invention; and

FIG. 12 is a partial calendar diagram including an expectation date for expected direct deposit and a time period or “buffer” around that date according to an embodiment of the present invention.

### DETAILED DESCRIPTION OF INVENTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

Applicants recognize a source of the problem with existing micro-lending and line of credit products, including inflexible repayment mechanisms and schedules. For example, many commonly-used loan and credit products, including credit cards, require repayments on a fixed schedule, typically monthly. Most borrowers, however, are paid more often than monthly, e.g., weekly, biweekly, or semimonthly. That is, employers often process payroll, and borrowers often receive paychecks (to include electronic deposits), other than monthly. Applicants recognize that borrowers often spend available money and funds, even if such funds are or should be committed, i.e., are budgeted, for loan repayment. Rather than attempt to set aside or secure funds to fulfill loan repayments, Applicants provide embodiments where loan repayments are scheduled to correspond to expected deposit dates, i.e., paydays.

As such, embodiments of the present invention advantageously provide flexible payment options for greater appeal to more underserved consumers and greater appeal to more situations than with existing micro-credit loan products. Advantages of embodiments of the present invention include larger loan amounts, multiple repayments, and the ability for customers to graduate to betters terms over time through demonstrated repayment performance, as opposed to other measurement that may have less to do credit worthiness than repayment, such as, for example, income level. For example, a consumer can graduate from a single-repayment loan program to a multiple-repayment loan program and once in a multiple-repayment program, can increase the adjustable line of credit limit and improve terms and conditions as understood by those skilled in the arts.

Through embodiments of the present invention, a consumer can improve the consumer's credit bureau scores as understood by those skilled in the art. For example, both positive and negative activity can be reported to credit bureaus regularly, e.g., monthly. Eligibility in the line of credit program, however, does not depend on bureau credit scores. Eligibility can depend, for example, on prior enrollment in a line of credit program associated with a prepaid card, including a program requiring a single repayment for a micro-loan and including a line of credit program that provides funds only in one or more preselected increments. Credit bureau scores may be used, for example, after an eligibility determination. Along with ongoing direct deposit data, bureau credit scores can be used in adjusting an amount for a credit limit associated with the line of credit, or altering the credit terms over time.

To further achieve these ends, embodiments of the present invention can include, for example, establishing for a customer a line of credit associated with the account, e.g., a prepaid card account, with a financial institution responsive to historical direct deposit data. The line of credit can have, for example, an adjustable line of credit limit, and one or more loans can be provided pursuant to the line of credit. Embodiments of the present invention can include, for example, loans having repayment dates corresponding to the customer's next multiple paydays (or benefits distribution days or other recurrent payments as understood by those skilled in the art), e.g., two to four repayments scheduled on traditional paydays. Embodiments of the present invention can also include, for example, receiving an electronic loan request from a customer via an electronic communication network for one or more loans. The electronic loan request, for example, can be pursuant to a line of credit.

Some embodiments of the present invention can also determine, for example, a repayment schedule responsive to a historical direct deposit data. The repayment schedule can include a schedule of multiple repayments corresponding to expected deposits. This enables for a larger loan amounts than a single-repayment loan, such as a payday loan. In particular, embodiments of the present invention can allow for a loan amount greater than an anticipated deposit. For example, if an expected paycheck will be $500, a traditional single-repayment payday loan may be limited to $500, or even less, so that the lender can be assured of repayment on the payday. In contrast, embodiments of the present invention can include loans in amounts of, for example, 75% to 150% of an average direct deposit amount. As understood by those skilled in the art, embodiments of the present invention can include, for example, an arithmetic mean or true average of direct deposit data; an Olympic average that calculates an average after ignoring a high and a low value so that no single point skews the data (and so that a minor illness or weekend of overtime do not affect the extension of credit); and other similar or related calculations of direct deposit data. Embodiments of the present invention, for example, can allow deposits within ,a certain range, e.g., 25% of a historical deposit data, to be used for credit limit calculations, and to determine an average direct deposit amount.

Embodiments of the present invention can also determine, for example, a repayment schedule so that there is a minimum period before any repayment is due. This, in effect, allows the skipping of an expected direct deposit if the expected direct deposit date is too close to the loan. Stated differently, embodiments of the present invention can include a buffer zone that separates the advancing of funds from a first scheduled repayment. For example, if a payday is every Friday according to the historical direct deposit data and if the buffer zone is one full day, i.e., 24 hours, then, for any loan advance on a Thursday, a first repayment may not be scheduled the next Friday (i.e., one day later) but instead the following Friday (i.e., eight days later).

Embodiments of the present invention can determine, for example, a repayment schedule responsive to an outstanding balance for a line of credit. This can include, for example, aggregating one or more loans for repayment purposes. Subject to the overall adjustable line of credit limit, one or more individual loans can be issued, providing maximum flexibility to a customer. For example, if a customer initiates a first loan for $100 on a Monday pursuant to an established line of credit, requesting four (4) repayments. The financial institution computer then determines a repayment schedule of four (4) repayments of $25 each for each of next Fridays, responsive to the direct deposit data indicating a weekly Friday payday. For purposes of this example, fees and interest are not included and the buffer zone is one day. Then on a Thursday after the Monday, the customer initiates a second loan for $400 pursuant to an established line of credit, requesting four (4) repayments. The financial institution computer then determines, i.e., recalculates, a repayment schedule. On the Friday immediately following the loans on Monday and Thursday, a repayment of $25 is scheduled, reflecting the first repayment for the first, $100 loan. Because Thursday is within the buffer zone for an expected deposit, no repayment for the second loan is scheduled until the following week. On the following Friday, a repayment of $125 is scheduled, responsive to the outstanding balance of $475 (i.e., $25 repayment for the first loan plus $100 repayment for the second loan). On the third and fourth Friday, a repayment of $125 is likewise scheduled and on the fifth Friday, a repayment of $100 is schedule to complete the pay off for both loans.

When a loan repayment is scheduled, e.g., on a Friday payday, the lender, through a computer, can attempt to debit the borrower's account, e.g., a prepaid card account, for the pre-scheduled repayment. Applicants recognize that payroll and other deposits can arrive earlier or even later than expected. Accordingly, embodiments of the present invention can selectively monitor, a borrower's account for an expected deposit from which to obtain repayment. That is, embodiments of the present invention can further include monitoring a borrower account for an expected direct deposit from a first time prior to an expectation date for the expected direct deposit and up to a second time after the expectation date for the expected direct deposit to thereby define a time period or “buffer” around the expected direct deposit. The buffer can, for example, be asymmetric, with a larger (or smaller) first duration prior to the expectation date than a second duration after the expectation date to accommodate a longer (or a shorter) period for an early deposit than a late deposit. By establishing a buffer around an expected direct deposit, example embodiments can enable a repayment for a loan from an expected direct deposit even if the expected direct deposit arrives early or late, as long as the deposit arrives during the buffer. Such example embodiments can result in efficient use of computer resources. In addition to fewer missed repayments and less delay associated with deposits, such example embodiments provide a system that can scale to accommodate large number of accounts and associated deposits. Example embodiments can allow, for example, for other deposits to the account, such as, for example, reimbursements, gifts, tax returns, and other unexpected deposits as understood to those skilled in the art, to proceed so that the funds are available for use by the borrower and loan repayment is obtained from the scheduled direct deposit.

Embodiments of the present invention provide, for example, for monitoring an account and evaluating deposits to the account using the Automated Clearing House (ACH) electronic communication network. As understood by those skilled in the art, Automated Clearing House (ACH) is the name of an electronic network for financial transactions, including electronic debits and credits, in the United States that is regulated by the Federal Reserve. For examples and explanations of prioritized payments from deposits, see also co-pending U.S. patent application Ser. No. 12/338,365, by Sorbe et al., titled “Transfer Account Systems, Computer Program Products, and Associated Computer-Implemented Methods” filed on Dec. 18, 2008; U.S. patent application Ser. No. 12/338,402, by Sorbe et al., titled “Transfer Account Systems, Computer Program Products, and Associated Computer-Implemented Methods” filed on Dec. 18, 2008; U.S. patent application Ser. No. 12/338,440, by Sorbe et al., titled “Transfer Account Systems, Computer Program Products, and Associated Computer-Implemented Methods” filed on Dec. 18, 2008; U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008; and U.S. patent application Ser. No. 12/338,645, by Sorbe et al., titled. “Transfer Account Systems, Computer Program Products, and Computer-Implemented Methods to Prioritize Payments from Preselected Bank Account” filed Dec. 18, 2008, each incorporated herein in their entireties.

Embodiments of the present invention can provide, for example, for obtaining one or more repayments responsive to a receipt of the expected direct deposit, the expected direct deposit being one of a predetermined hierarchy of deposit sources, the predetermined hierarchy of deposit sources excluding preselected deposit sources. An example of preselected exclusions from the hierarchy can include, for example, payments for child support or certain government benefits, grants, or payments. Stated differently, when an embodiment of the present invention evaluates an ACH deposit and determines that the deposit is a child support payment, it can be excluded as a source of funds for repayment so that the funds from the child support payment are made available in the account and repayment of the loan will wait for additional deposits. As understood by those skilled in the art, deposits, including ACH payments, include source information that can identify the source of a deposit, allowing a list or database of preselected deposit sources to be checked to thereby verify a source for exclusion from repayment.

The hierarchy of deposit sources can include, for example, an option for payments by mail. Customers can request, for a fee, e.g., a $100 setup fee, to make payments by mail rather than have the payments electronically obtained from their account or deposits. Federal Banking Regulation E, as understood by those skilled in the art, provides that credit cannot be extended based upon the requirement of recurring electronic payments. Embodiments of the present invention that include a payment by mail option and establishing the line of credit by a request from the customer should advantageously alleviate Regulation E concerns. Also, to the extent that eligibility in a line of credit program depends, for example, on prior enrollment by the customer in the line of credit program associated with a prepaid card, Regulation E concerns are lessened, as the customer will have expressly requested an enhanced line of credit program to establish eligibility for the program.

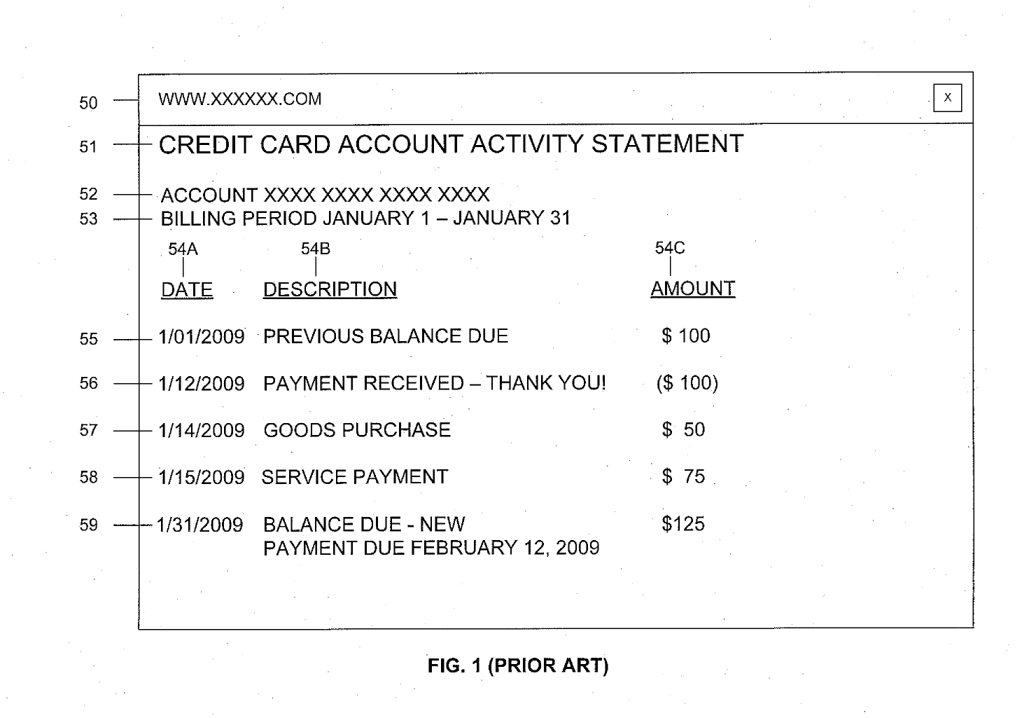

Turning to the figures, applicants recognize a source of the problem with existing micro-lending and existing line of credit products include inflexible repayment mechanisms and schedules. For example, as illustrated in FIG. 1, many commonly-used loan and credit products require repayments on a fixed schedule, typically monthly. For example, the limitations of the prior art are shown by the prior art credit card account activity statement 51, which can be accessed through the a website 50 on the Internet, the World Wide Web, or other electronic communications network as understood by those skilled in the art. The prior art credit card account activity statement 51 can include, for example, a unique account identifier 52 or account number. The prior art credit product allows for the purchase of goods 57 and services 58 on credit and typically expects repayment once during each billing period 53 or cycle; that is, the product has a single balance due date 59, not multiple payment dates. Even if the customer is aid more offer than the billing period, i.e., weekly, biweekly, or semimonthly, the customer typically makes one payment per billing cycle 56. Most customers, however, are paid more frequently than monthly, e.g., weekly, biweekly, or semimonthly. Employers often process payroll, and customers often receive paychecks (including electronic deposits), other than monthly. Applicants recognize that customers often spend available money and funds, even if such funds are or should be committed, i.e., budgeted, for loan repayment. Rather than attempt to set aside or secure funds to fulfill loan repayments, Applicants provide embodiments where loan repayments are, for example, scheduled to correspond to expected deposit dates, e.g., paydays.

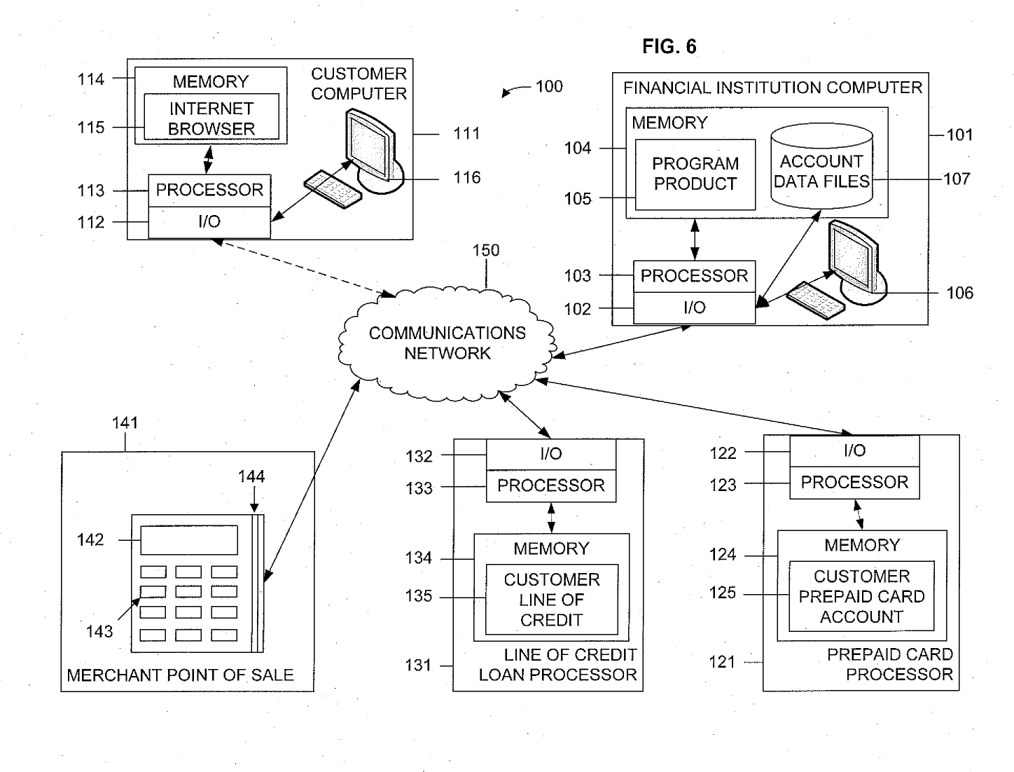

As illustrated in FIG. 6, according to embodiments of the present invention, a system 100 can include a customer computer 111, a financial institution computer 101, a prepaid card processor 121, a line of credit loan processor 131 and a merchant point of sale terminal 141 connected over a communications network 150 in a traditional financial services system implementation to advance a line of credit to a prepaid card holder, and deduct payments on loans from the line of credit from the prepaid card balance without fixed payment programs or monthly statements. As one skilled in the art will appreciate, communications network 150 may be a wide area network (WAN) such as the internet, a telephonic network, a LAN or a combination of one or more of the above. The customer computer 111 connects a customer via the communications network to e.g. a customer services account. As such, the customer computer includes and I/O interface 112, a processor 113, a memory 114, and an internet browser 115 stored thereon for interaction with the communications network 150 to access a prepaid card account.

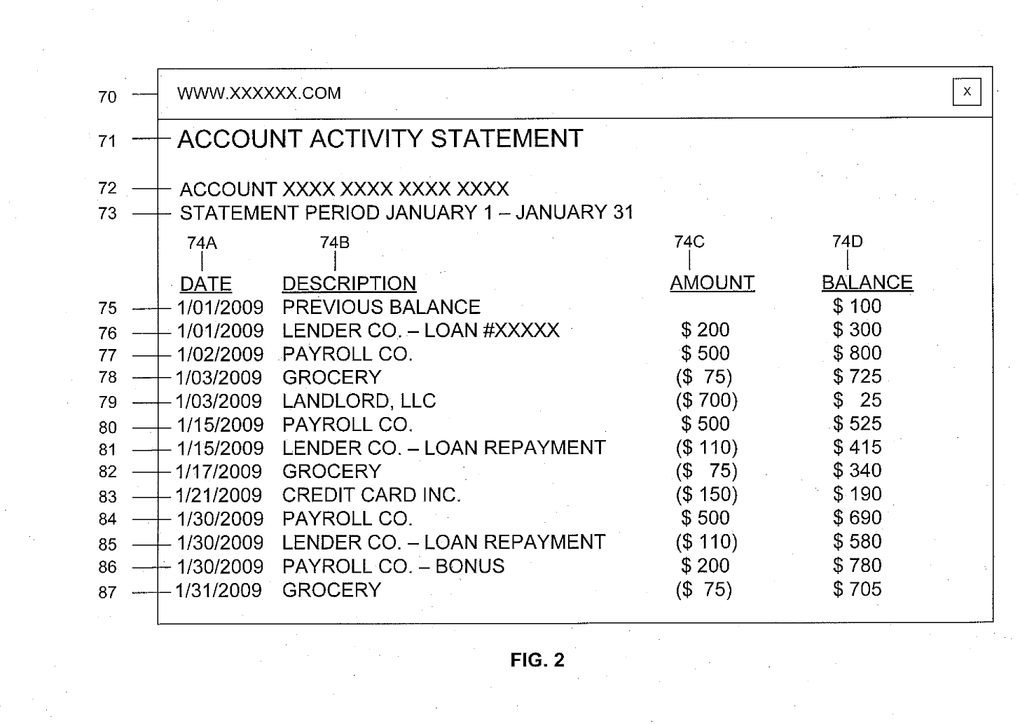

As illustrated on FIG. 2, the prepaid customer may be able to access account activity statements in some embodiments, e.g., an account activity statement 71 associated with a line of credit as viewed on a display screen 116 of the customer computer 111. Such an account activity statement 71, which may be accessed through the a website 70 on the Internet, the World Wide Web, or other electronic communications network as understood by those skilled in the art, illustrates the types of prepaid card account records embodiments of the machine, computer program product and computer-implemented methods of the invention may store on the financial services computer for access by same. (See also item 150 in FIG. 6.) The account activity statement 71 may include, for example, a unique account identifier 72 or account number. The account activity statement 71 can include, for example, a statement period 73. Unlike the prior art billing period of a prior art credit card account activity statement 53 in FIG. 1, a statement period may include multiple repayment dates, e.g., repayments 81 and 85. Each transaction listed may also include a transaction date 74A; a description 74B of the transaction; and a transaction amount 74C, including debits from the account (i.e., out-going payments in parentheses) and credits to the account (i.e., deposits without parentheses). Each transaction listed can also include, for example, a running balance 74D.

As further illustrated in FIG. 2, an account activity statement 71 may also include, for example, a previous balance 75, e.g., a carry over or remaining amount, from the prior statement. The account activity statement 71 can include, for example, various debits from the account, including payments for goods and services, such as, rent, groceries, and bills, see, e.g., 78, 79, 82, 83, 87. The account activity statement 71 can include, for example, deposits, e.g., recurring direct deposits 77, 80, and 84 such as typically associated with payroll. The account activity statement 71 can include, for example, deposits, e.g., one-time or non-recurring deposits 86 such as typically associated with a bonus, a reimbursement, a commission, or over-time. The account activity statement 71 can include, for example, a loan transaction 76, wherein loan proceeds are deposited in the account. In addition, the account activity statement 71 can include, for example, loan repayments 81 and 85, including a repayment for loan principle, interest, and fees.

Returning to FIG. 6, the merchant point of sale terminal (“POS”) or reader 141 may use the data on a prepaid card, for example, to facilitate a transaction. For example, when the prepaid card 90 is swiped through a slot 144 on a point of sale terminal or other card reader 141, the data on the magnetic stripe 94 is read and processed by the reader 141. The reader 141 can then communicate through an electronic communications network 150 to, for example, a prepaid card processor 121 or a financial institution computer 101. The reader 141, communicates the account data as read from the card, as well as other data, such as, an amount of a proposed transaction for approval. Other data, for example, can be entered by merchant personnel (e.g., an amount of the transaction), the consumer (e.g., a PIN, or security code), or bank personnel (e.g., a security approval). The prepaid card processor 121 or financial institution computer 101 can then utilize the account information and other information or data to authorize or reject a purchase by, for example, determining whether a proposed purchase by the consumer is less than an amount of funds remaining in the account associated with the prepaid card. Moreover, optional security measures, including, for example, a mismatch between a PIN supplied by the consumer and a PIN stored on the card or in a database 107, can result in the rejection of a proposed transaction. The prepaid card processor 121 or financial institution computer 101 then perform certain functions, including responding to the authorization request so that a point-of-sale displays an indication of approval or rejection, resulting in a visual depiction to a merchant of the approval or rejection of the proposed transaction. Also, the prepaid card processor 121 can, for example, write data to a database to record a transaction, to debit available funds from an account associated with the prepaid card 90, and to credit directly or indirectly a merchant for a purchase. In addition to purchase authorization, embodiments of the present invention also can include customer inquiries into recent transactions or a balance inquiry, i.e., an amount of remaining value associated with the prepaid card. Embodiments of the present invention may also include, for example, debit cards, gift cards, and other similar cards and mechanisms in addition to prepaid cards, as understood by those skilled in the art.

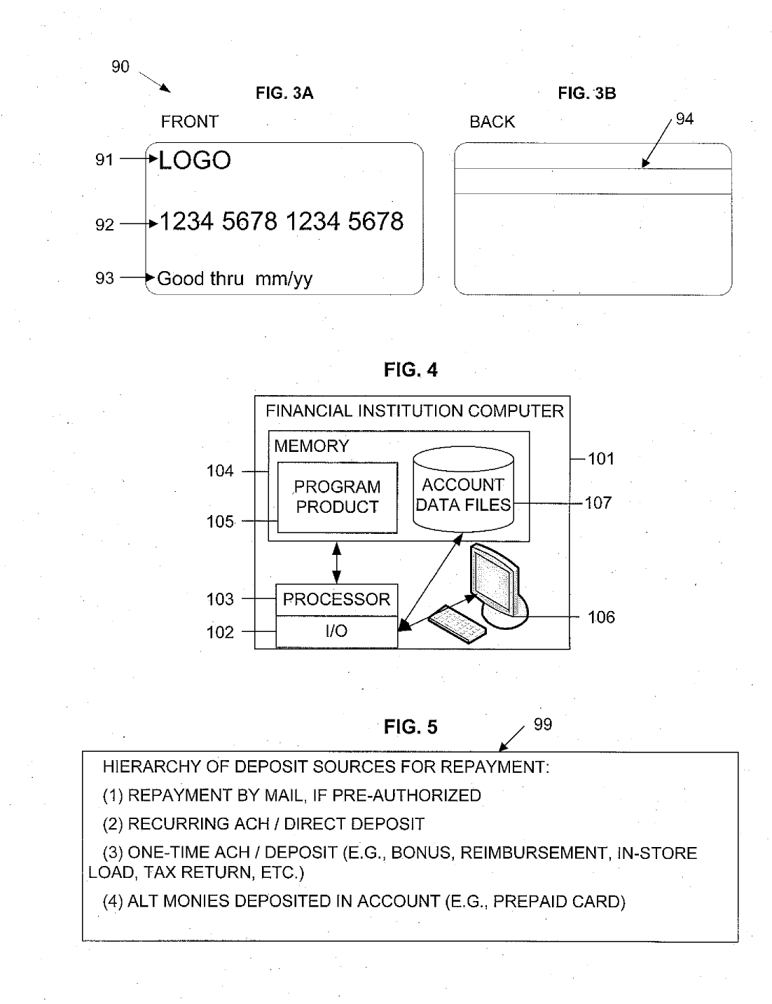

In such embodiments, as illustrated in FIGS. 3A and 3B, the present invention may associate, for example, a prepaid card 90 with the prepaid card account and the customer. As understood by those skilled in the art, a prepaid card can have indicia 91, e.g., logos, slogans, source identifiers, of a sponsoring bank and of a prepaid card processor; a serial number 92; and expiration date 93. The structures of various types of specific cards, e.g., magnetic stripe 94, and types of material are well known to those skilled in the art and can be used with embodiments of the present invention. Typically, a card 90 is formed from plastic and has a magnetic stripe 94 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or having a customer purchase or otherwise convert or receive cards already formed.

As one skilled in the art will appreciate, the magnetic stripe card 90 can store information, or data, e.g., account information, by modifying the magnetism of particles on the magnetic stripe 94 on the card. Prepaid card data, can be read by swiping the card through a slot 144 past a reading head of a card reader device, including most point-of-sale hardware 141. See, e.g., FIG. 6. Typically, there are two tracks of data on a magnetic card used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN.

Returning to FIG. 6, and as previously mentioned, the system may also include a prepaid card processor 121 and a line of credit load processor 131. Both the prepaid card processor and line of credit loan processor include an input/output (“I/O”) device 122/132, processors 123/133, and memory 124/134. Memory 134 stores a customer line of credit, and prepaid card processor memory 124 stores a prepaid card account. As one skilled in the art will appreciate, while the line of credit processor and prepaid card processor are described as being separate from the financial institution computer across the communications network, optionally one or both may be part of the financial institution computer, as, e.g., separately networked machines, servers or devices connected using a local area network (LAN) or virtual private network (VPN). As one skilled in the art will also appreciate, I/O interfaces 122/132 can be any I/O interfaces including, but not limited to a network card/controller connected by a PCI bus to the motherboard, or hardware built into the motherboard of the prepaid card processor 121 or line of credit processor 131 to connect same to the communications network for access by the financial services computer, customer computer, or other devices. As can be seen, the I/O interfaces 122/132 are connected to the processors 123/133. Processors 123/133 are the “brains” of the prepaid card processor 121 and line of credit processor 131, and as such execute program product [not shown] and work in conjunction with the I/O interfaces 122/132 to direct data to memory 124/134 and to send data from memory 124/134 to the communications network 150. Processors 123/133 can be any commercially available processor, or plurality of processors, adapted for use for the prepaid card processor 121 and line of credit processor 131, e.g., Intel® Xeon® multicore processors, Intel® micro-architecture Nehalem, AMD Opteron™ multicore processors,. etc. As one skilled in the art will appreciate, processors 123/133 may also include components that allow the prepaid card processor 121 and line of credit processor 131 to be connected to a display [not shown] and keyboard that would allow a user to directly access same.

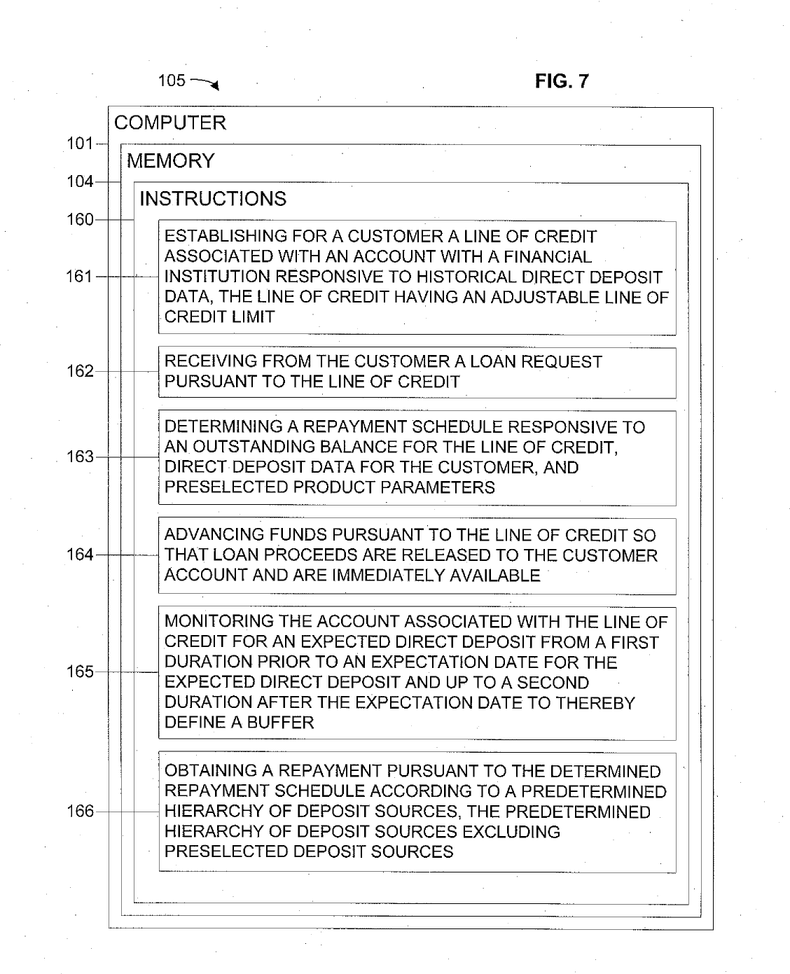

Returning to the figures, financial institution computer 101 implements, the computer program product and methods of the instant invention. As illustrated on FIG. 4, embodiments of the financial services computer can include, for example, a machine consisting of, e.g., a server, plurality of servers or other computers, to schedule and obtain loan repayments, where the machine is associated with a financial institution and configured as a financial institution computer 101. Embodiments of the machine 101 can also provide, for example, a loan with a financial institution. The loan can be, for example, pursuant to a line of credit with the financial institution. The machine 101 can include, for example, an I/O interface 102 for communicating with a customer and for interacting with an account associated with a customer. The machine 101 can include, for example, a processor 103 positioned to receive a loan request, advance funds, monitor an account for a deposit, and obtain a repayment. The machine 101 can also include, for example, an optional display 106. In addition, the machine 101 can include, for example, a database 107, including account data files and a non-transitory memory 104 having stored therein a computer program product 105 as described herein and illustrated in FIG. 7.

As one skilled in the art will also appreciate, I/O interface 102 can be any I/O interface including, but not limited to a network card/controller connected by a PCI bus to the motherboard, or hardware built into the motherboard of the financial services computer 101 to connect same to the communications network. As can be seen, the I/O interface 102 is connected to the processor 103. Processor 103 is the “brains” of the financial services computer 101, and as such execute program product 105 and work in conjunction with the I/O interface 102 to direct data to memory 104 and to send data from memory 104 to the communications network 150. Processor 103 can be any commercially available processor, or plurality of processors, adapted for use with the financial services computer 101, e.g., Intel® Xeon® multicore processors, Intel® micro-architecture Nehalem, AMD Opteron™ multicore processors, etc. As one skilled in the art will appreciate, processor 103 may also include components that allow the financial services computer 101 to be connected to a display 106 and keyboard that would allow a user to directly access same.

As can be seen, program product 105 is stored in the memory of the financial institution computer and is operable on same. As illustrated in FIG. 7, the computer program product 105 can be, for example, stored on a non-transitory tangible computer memory 104 and operable on the processor 103. The computer program product 105 can include, for example, a set of instructions 160 that when executed by the processor 103 cause a computer 101 to determine a repayment schedule for one or more loans and obtain one or more loan repayments pursuant to a repayment schedule by performing various operations. The computer program product 1.05 can also cause a computer 101 to provide a loan for a customer with a financial institution by performing various operations. The loan may be, for example, pursuant to a line of credit. The operations can include, for example, establishing for a customer an account, e.g., a prepaid account, with a financial institution. The operations can include, for example; establishing a line of credit associated with the account with a financial institution responsive to historical direct deposit data, the line of credit having an adjustable line of credit limit 161. The operations can include, for example, receiving from the customer an electronic loan request. The electronic loan request can be pursuant to the line of credit 162. The operations can include, for example, determining a repayment schedule responsive to an outstanding balance for the line of credit, direct deposit data for the customer, and preselected product parameters 163. The operations can include, for example, determining a repayment schedule responsive to the electronic loan request, direct deposit data for the customer, and preselected product parameters. The operations can include, for example, advancing funds to the account so that it is immediately available 164. The operations can include, for example, monitoring the account for an expected direct deposit from a first duration prior to an expectation date for the expected direct deposit and up to a second duration after the expectation date for the expected direct deposit to thereby define a buffer around the expected direct deposit 165. The operations can include, for example, obtaining one or more repayments responsive to a receipt of the expected direct deposit, the expected direct deposit being one of a predetermined hierarchy of deposit sources, the predetermined hierarchy of deposit sources excluding preselected deposit sources 166.

As illustrated on FIG. 5, embodiments of the present invention can include, for example, a hierarchy of deposit sources for repayment. The hierarchy can include, for example, first a repayment by mail, if pre-authorized; second, a recurring direct deposit deposited in the account; third, a one-time deposit deposited in the account; and fourth, alternative monies deposited in the account. That is, embodiments of the present invention can include an order, i.e., a preference or priority, of deposit sources to be used for repayment so that a lower priority deposit source will not be used if a higher priority source is available. For example, as illustrated. in FIG. 2, a loan repayment 85 is made from a recurring deposit 84 and not a one-time deposit 86, i.e., loan repayment is made from an expected $500 deposit for salary and not from a lower priority deposit for a bonus, even if both deposits occur on the same date. Flexible repayment embodiments provide confidence and dependability to a borrower and enable immediate access to gifts, loans, and other one-time deposits through the prepaid card. In additions, the flexible repayment embodiments provide confidence to a lender that the loan repayments will be made as scheduled and that the borrower will not spend the funds prior to repayment.

According to an embodiment of the present invention, if the expected direct deposit does not arrive, or the deposited amount is below the amount of a scheduled repayment from that expected direct deposit, repayment can still be obtained reasonably and efficiently. For example, a one-time deposit such as a gift, bonus, reimbursement, in-store load, tax return, or other deposit as understood by those skilled in the art, can supply the funds necessary to cover a repayment scheduled from an expected direct deposit. Additionally, repayment can be debited directly from the account, e.g., from the prepaid card. Embodiments, for example, can provide a delay before pursuing another form of repayment and notice (including to an e-mail account) of a delinquency and the additional steps taken to obtain payment. If, for example, a payment by mail is expected by a particular date and the payment fails to arrive, then after a grace period, e.g., three days, funds may be obtained from other sources

In the event that repayment is not received by the financial institution, as understood by those skilled in the art, credit may be suspended. Various reasons and events may cause the computer 101 to suspend the account, including if a payment is missed, if a recurring direct deposits is interrupted, if the credit limit is subject to a decrease (and the outstanding balance is above the new credit limit), and if other terms or conditions are violated. As understood by those skilled in the arts, credit bureau reports and scores can indicate an event that can cause credit to be suspended.

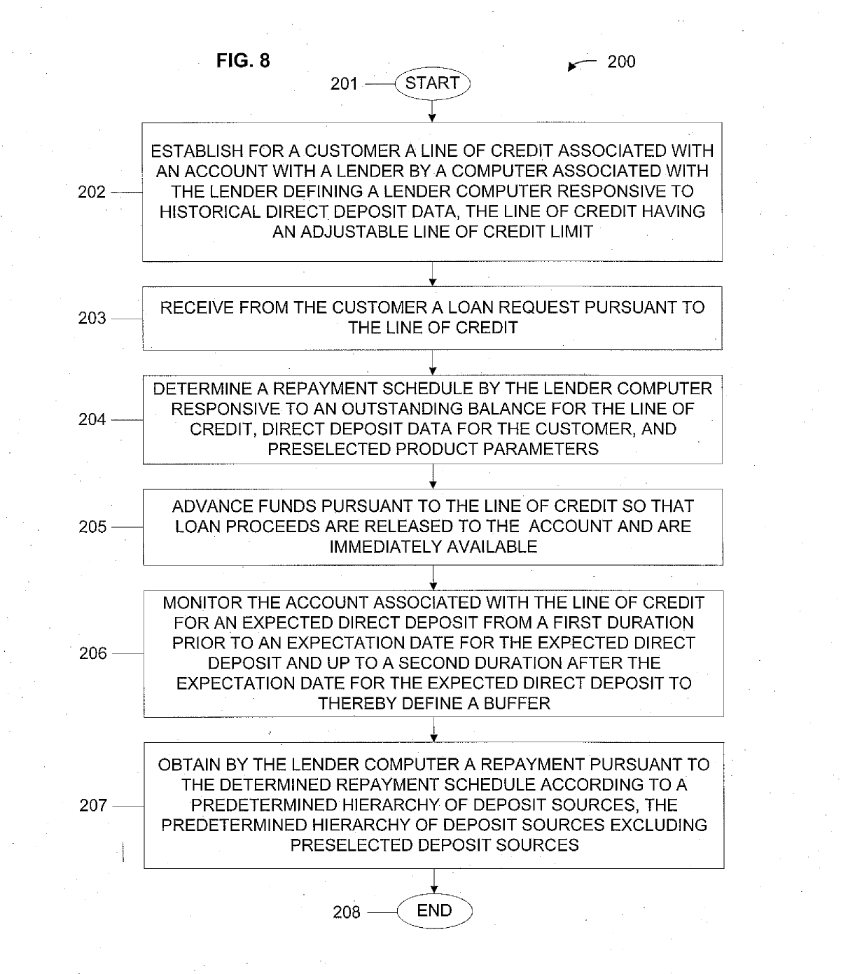

As illustrated in FIG. 8, embodiments of the present invention can include, for example, a computer-implemented method 200 to cause a computer configured as a financial institution computer to perform a process of advancing one or more loans to an account and a process of obtaining one or more loan repayments pursuant to a repayment schedule. Embodiments of the computer-implemented method may include providing one or more loans. The one or more loans can be, for example, pursuant to a line of credit having an adjustable line of credit limit. The computer-implemented method 200 can include, for example, establishing for a customer a line of credit associated with an account with a financial institution by a computer associated with the financial institution defining a financial institution computer responsive to historical direct deposit data, the line of credit having an adjustable line of credit limit 202. The computer-implemented method 200 can include, for example, receiving from the customer an electronic loan request 203. The electronic loan request can be pursuant to a line of credit and communicated over an electronic network. The computer-implemented method 200 can include, for example, determining a repayment schedule by the financial institution computer responsive to receiving the electronic loan request, direct deposit data for the customer, and preselected product parameters 204. Determining the repayment schedule can, for example, also be responsive to an outstanding balance for the line of credit. The computer-implemented method 200 can include, for example, advancing funds via an ACH electronic communication network so that loan proceeds are released to the account and are immediately available 205. The advancing funds, for example, can also be pursuant to the loan of credit. The computer-implemented method 200 can include, for example, monitoring the account by the financial institution computer for an expected direct deposit from a first duration prior to an expectation date for the expected direct deposit and up to a second duration after the expectation date for the expected direct deposit to thereby define a buffer around the expected direct deposit 206. The computer-implemented method 200 can include, for example, obtaining by the financial institution computer a repayment pursuant to the determined repayment schedule according to a predetermined hierarchy of deposit sources 207; the predetermined hierarchy of deposit sources can exclude preselected deposit sources.

Example embodiments of the present invention can include, for example, the account being a prepaid card account so that the step of advancing funds thereby converts the prepaid card 90 into a loan delivery apparatus and so that the financial institution computer 101 converts electronic loan request data from the customer into a value associated with the prepaid card 90 capable of purchasing goods and services. (See, e.g., items 78 and 79 in FIG. 2.) Embodiments of the present invention include, for example, an adjustable line of credit limit corresponding to an amount between about 75% to about 150% of an average direct deposit amount. Preselected product parameters, for example, can require a minimum payment for all scheduled payments when there is an outstanding balance: A minimum payment of, for example, $100 may result in a $150 loan have only two repayments, the first repayment being the $100 minimum and the second being the balance of the loan, or $50 (assuming no interest of fees for example purposes). Example embodiments of the present invention can include, for example, a repayment schedule that includes two to four payments.

Example embodiments include, for example, wherein the financial institution is a federally chartered bank and the line of credit is a bank product so that the line of credit complies with federal Regulation Z, as understood by those skilled in the art.

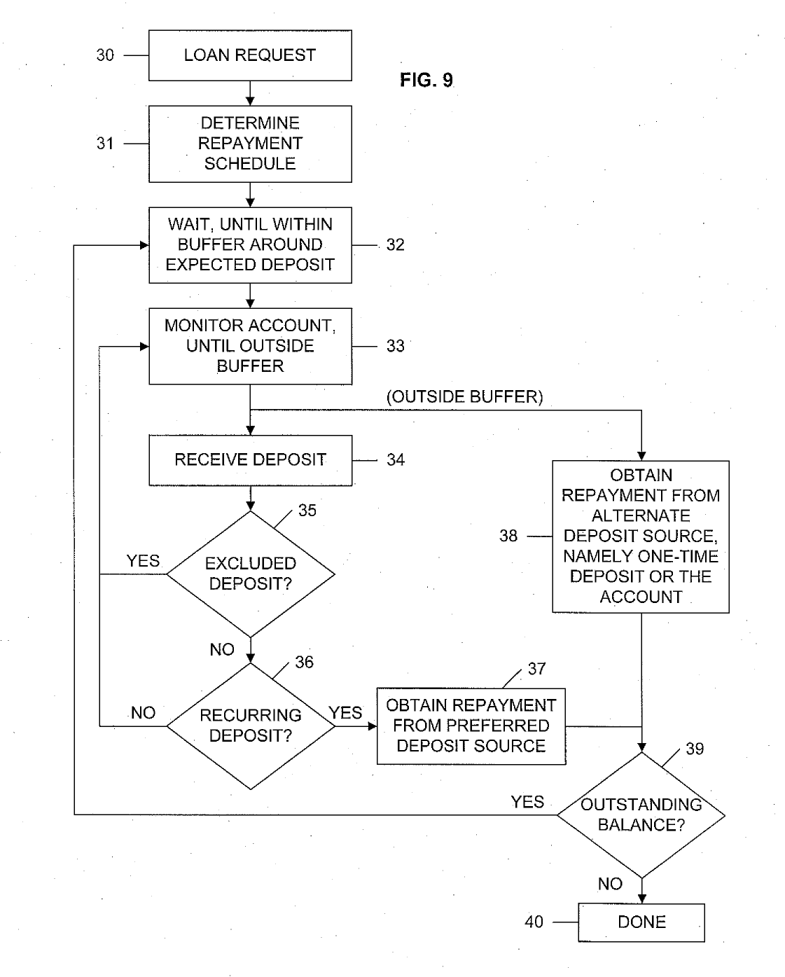

As illustrated in the flow chart in FIG. 9, embodiments provide, for example, a computer-implemented method of scheduling and obtaining loan repayments according to a hierarchy of deposit sources. The computer-implemented method can include an electronic loan request 30 for one or more loans. Next, the computer determines a repayment schedule. The repayment schedule can be, for example, responsive to an outstanding balance for the one or more loans, direct deposit data for the customer, and preselected product parameters. For example, if the direct deposit data indicates that the customer is paid every two weeks, the determined repayment schedule can include an expected deposit every two weeks. The computer can, for example, wait for the expected deposit, specifically, until within a buffer around the expected deposit 32. During the buffer, the computer can monitor the account for deposits 33. When a deposit is received 34, the computer can determine if it is an excluded deposit 35, such as a child-support payment. If the deposit is an excluded deposit, i.e., a deposit from an excluded source, then the computer can continue to monitor the account 33 for an additional deposit. If the deposit is not excluded, the computer can next determine if the deposit is a recurring deposit 36. If the deposit is not a recurring deposit according to the direct deposit data, then the computer can continue to monitor the account 33 for an additional deposit. Otherwise, the computer can obtain repayment from the preferred deposit source, e.g., a recurring deposit that is not from an excluded deposit source 37. Next, the computer can determine is there is an outstanding balance of the one or more loans 39. If there is an outstanding balance of the one or more loans, and the scheduled repayment was not paid in full, then the computer can continue to monitor the account for additional deposits to pay the scheduled repayment in full until outside the buffer. If there is an outstanding balance of the one or more loans, but the scheduled repayment was paid in full, the computer can then wait for the next expected deposit, e.g., the next payroll deposit—specifically, until within the next buffer around the next expected deposit 32. If there is not an outstanding balance for the one or more loans, the method is done 40. If the scheduled repayment is not paid in full once outside the buffer, the computer can cease monitoring the account until the next buffer and obtain repayment from an alternate source, e.g., a one-time deposit or from alterative monies deposited in the account 38. Stated differently, if a recurring deposit that is not excluded does not satisfy the scheduled repayment, the computer can obtain payment from one or more less-preferred source on the hierarchy of deposit sources. See also, e.g., FIG. 5. Likewise, insufficient funds for repayment can result in the computer seeking repayment from one or more less-preferred source on the hierarchy of deposit sources.

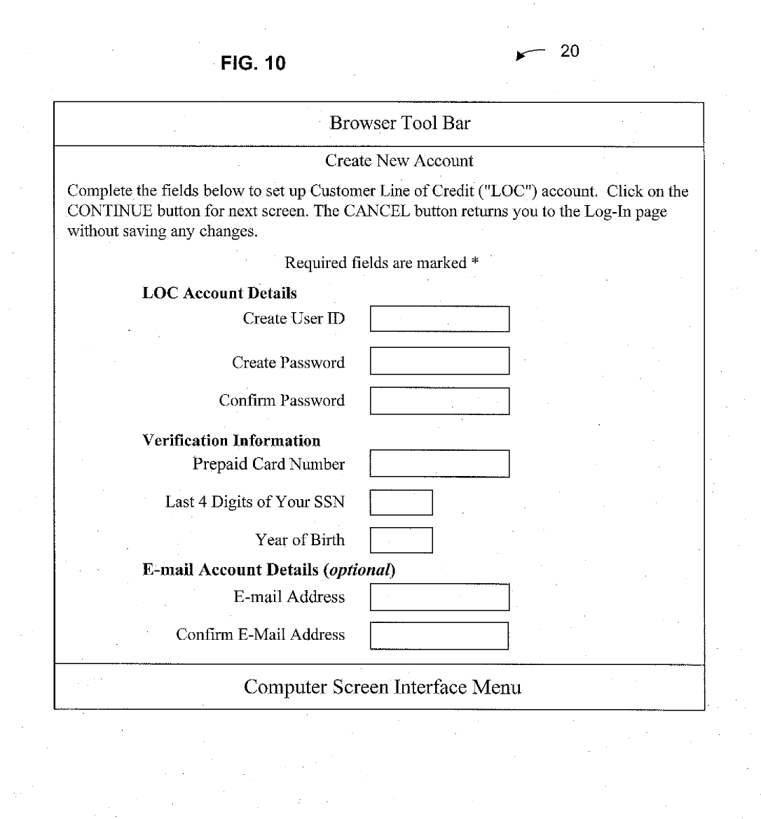

As illustrated in FIG. 10, embodiments of the present invention can include, for example, an access interface 20 for a customer to set up a line of credit associated with an account, e.g., a prepaid card account. The access interface can also enable the customer to make an electronic loan request pursuant to the line of credit. An access interface 20 embodiment can include a computer program product and system in the form of a graphical user interface of a display of a computer as understood by those skilled in the art. See also, e.g., item 116 in FIG. 6.

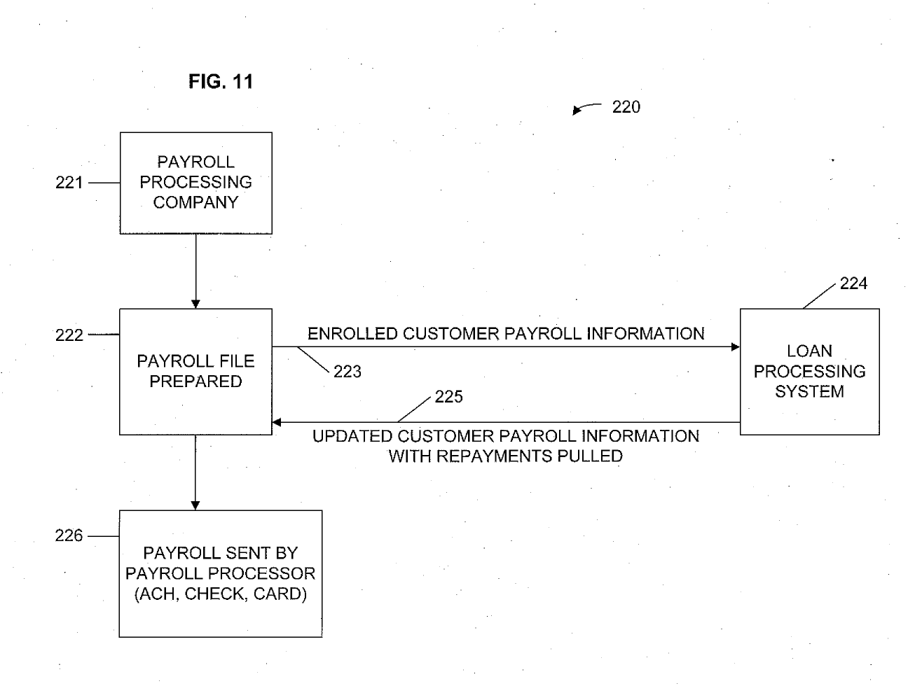

As illustrated in FIG. 11, embodiments of present invention can include, for example, a payroll processing company 221 that processes direct deposits. Embodiments of the computer program product and computer-implemented methods, for example, can be added to product or service offerings by the payroll processing company 221 so that it can be offered to their customers independent of bank or product (demand deposit account (DDA), payroll card, or prepaid card), by taking money or funds out at the source, i.e., as the payroll file is prepare 222 and before the direct deposit is even originated or loaded onto a prepaid card. These embodiments can also allow the processing company 221 to have more direct information on employment history. A payroll processing company 221 can also use a loan processing system 224, loan processor, or other payment processor either within their facilities or as an outsourcing entity to allow the provision of enrolling and providing customer payroll information 223 and for tracking and reconciling repayment or updated customer payroll information with repayments pulled 225. The payroll can be sent, loaded or processed by a payroll processor 226 for ACH transmittal, check generation, or card loading/providing, for example (see, e.g., FIG. 11). These embodiments of associated methods, for example, can include providing a card 90, with magnetic stripe coded information or other coded card as understood by those skilled in the art, as well as a card number 92 and expiration date 93 if desired on a front of the card 90 (see, e.g., FIGS. 3A-3B) to an employee who gets direct deposit to a demand deposit account whereby the consumer borrows funds from the service/product and has those funds direct deposited onto the card instantly and repaid by pulling funds from the direct deposit file prior to sending to the other bank account to repay the amount withdrawn.

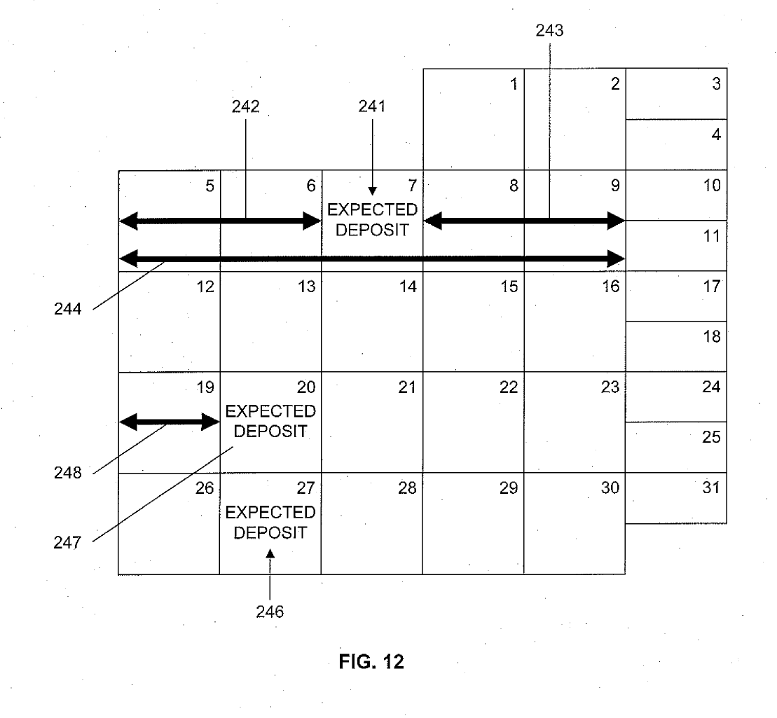

As illustrated in FIG. 12, embodiments of the present invention can include, for example, monitoring the account associated with the line of credit for an expected direct deposit from a first time prior 242 to an expectation date 241 for the expected direct deposit and up to a second time 243 after the expectation date 241 for the expected direct deposit to thereby define a time period or “buffer” 244 around the expected direct deposit. A buffer 244 around the expected direct deposit can begin, for example, two days before and end two days after the expectation date 241 for the expected direct deposit so that the financial institution computer 101 does not miss an early or late direct deposit.

As further illustrated in FIG. 12, embodiments of the present invention can include, for example, providing a minimum period before any repayment is due to thereby define a buffer zone 248. Buffer zone embodiments can allow, for example, in effect the skipping an expected direct deposit 247 for repayment purposes in favor of the following expected deposit 246 if the expected direct deposit date 246 is too close to the loan. For example, as illustrated in FIG. 12, a loan advanced within buffer zone 248 for an expected deposit 247 (i.e., a loan advanced on the 19th in the calendar within the buffer zone of the expected deposit on the 20th) would have a first scheduled repayment corresponding to the following expected deposit 246 and not the immediate expected deposit 247 (i.e., a first scheduled repayment on the 27th rather than the on the 20th in the calendar).

In the various embodiments of the invention described herein, a person having ordinary skill in the art will recognize that various types of memory are readable by a computer such as the memory described herein in reference to the various computers and servers, e.g., bank computer, computer server, financial institution computer, prepaid card processors, or other computers with embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood by those skilled in the art that such media can be at other locations instead of, or in addition to, the locations described to store computer program products, e.g., including software thereon.

This application is a continuation and claims priority and benefit to U.S. patent application Ser. No. 12/889,281, by Galit, et al., titled “Computer-Implemented Methods, Computer Program Products, and Systems for Enhanced Loan Product Repayments” filed on Sep. 23, 2010, which claims priority and benefit to U.S. Provisional Patent Application No. 61/245,095, by Galit et al., titled “Computer-Implemented Methods, Program Products, and Systems for Enhanced Loan Product Repayments” filed on Sep. 23, 2009, all and each of which are incorporated herein by reference in their entireties. This application also relates to: U.S. patent application Ser. No. 12/338,365, by Sorbe et al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,402, by Sorbe et al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,440, by Sorbe et al., titled “Transfer Account Systems, Computer Program Products, and Associated Computer-Implemented Methods” filed on Dec. 18, 2008, which claims priority to U.S. Provisional Patent Application No. 61/016,213; U.S. patent application Ser. No. 12/338,584, by Sorbe et al., titled “Transfer Account Systems, Computer Program Products, and Computer-Implemented Methods to Prioritize Payments from Preselected Bank Account” filed Dec. 18, 2008, which claims priority to U.S. Provisional Patent Application Nos. 61/016,213 and 61/052,454; U.S. patent application Ser. No. 12/338,645, by Sorbe et al., titled “Transfer Account Systems, Computer Program Products, and Computer-Implemented Methods to Prioritize Payments from Preselected Bank Account” filed Dec. 18, 2008, which claims priority to U.S. Provisional Patent Application Nos. 61/016,213 and 61/052,454; U.S. patent application Ser. No. 12/389,749, by Sorbe et al., titled “Methods to Advance Loan Proceeds on Prepaid Cards, Associated Systems and Computer Program Products” filed on Feb. 20, 2009, which claims priority to U.S. Provisional Patent Application No. 61/029,975; U.S. patent application Ser. No. 12/417,199, by Ahlers et al., titled “System, Program Product, and Associated Methods to Authorize Draw for Micro-Credit Attached to a Prepaid Card” filed Apr. 2, 2009, which claims priority to U.S. Provisional Patent Application No. 61/042,612; U.S. patent application Ser. No. 12/417,211, by Ahlers et al., titled “System, Program Product, and Associated Methods to Authorize Draw for Micro-Credit Attached to a Prepaid Card” filed Apr. 2, 2009, which claims priority to U.S. Provisional Patent Application No. 61/042,612; U.S. patent application Ser. No. 12/338,684, by Ahlers et al., titled “Computer-Implemented Methods, Program Product, and System for Micro-Loan Management” filed on Dec. 18, 2008, which claims priority to U.S. Provisional Patent Application Nos. 61/016,213, 61/052,454, 61/042,612, 61/042,624, 61/032,750, 61/082,863, 61/053,056 and 61/029,975; U.S. patent application Ser. No. 12/338,712, by Galit et al., titled “Computer-Implemented Methods, Program Product, and System to Enhance Banking Terms Over Time” filed on Dec. 18, 2008, which claims priority to U.S. Provisional Patent Application Nos. 61/016,213, 61/060,559, 61/052,454, 61/029,975, 61/042,612, 61/042,624, 61/032,750, 61/082,863, and 61/053,056; U.S. patent application Ser. No. 12/417,162, by Ahlers et al., titled “System, Program Product, and Method For Debit Card and Checking Account Autodraw” filed on the Apr. 2, 2009, which claims priority to U.S. Provisional Patent Application Nos. 61/042,624, 61/060,559, 61/052,454, 61/082,863 and 61/042,612; U.S. patent application Ser. No. 12/465,277, by Galit et al., titled “System, Program Product, and Computer-Implemented Method for Loading a Loan on a Pre-Paid Card” filed May 13, 2009,which claims priority to U.S. Provisional Patent Application Nos. 61/053,056 and 61/060,559; U.S. patent application Ser. No. 12/465,306, by Galit et al., titled “System, Program Product, and Computer-Implemented Method for Loading a Loan on an Existing Pre-Paid Card” filed May 13, 2009, which claims priority to U.S. Provisional Patent Application Nos. 61/053,056, 61/060,559 and 61/082,863; U.S. patent application Ser. No. 12/465,803, by Galit et al., titled “A Pre-Paid Card Transaction Computer to Load a Loan on a Pre-Paid Card” filed May 14, 2009, which claims priority to U.S. Provisional Patent Application No. 61/053,056, all and each of which are incorporated herein by reference in their entireties.

Many modifications and other embodiments of the invention will come to the mind of those skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A computer associated with a financial institution to define a financial institution computer to provide a plurality of line of credits associated with a plurality of prepaid cards, the computer comprising:
one or more processors; and
one or more non-transitory memories encoded with computer program, the computer program comprising a set of instructions that, when executed by the one or more processors, perform the operations of:
establishing a plurality of line of credits associated with a plurality of prepaid card accounts with a financial institution responsive to historical direct deposit data, each of the plurality of line of credits having an adjustable line of credit limit,
determining a repayment schedule responsive to receiving a loan request for one of the plurality of line of credits, the repayment schedule further being responsive to direct deposit data for a customers associated with the one of the plurality of line of credits and preselected product parameters,
advancing funds to one of the plurality of prepaid card accounts associated with the one of the plurality of line of credits so that the funds are immediately available,
monitoring the one of the plurality of prepaid card accounts associated with the one of the plurality of line of credits for an expected direct deposit from a first duration prior to an expectation date for the expected direct deposit and up to a second duration after the expectation date for the expected direct deposit to thereby define a buffer around the expected direct deposit, and
obtaining a repayment pursuant to the repayment schedule according to a predetermined hierarchy of deposit sources, the predetermined hierarchy of deposit sources excluding preselected deposit sources.

2. A computer as defined in claim 1, wherein the operation of advancing funds thereby converts a prepaid card associated with the one of the plurality of prepaid card accounts into a loan delivery apparatus and so that the computer converts loan request data from the customer into a value associated with the prepaid card capable of purchasing goods and services.

3. A computer as defined in claim 1, wherein the adjustable line of credit limit corresponds to an amount between about 75 percent to about 150 percent of an average direct deposit amount.

4. A computer as defined in claim 1, wherein the repayment schedule includes two to four payments.

5. A computer as defined in claim 1, wherein the buffer around the expected direct deposit begins two days before the expected direct deposit and ends two days after the expected direct deposit so that the computer does not miss an early or late direct deposit.

6. A computer as defined in claim 1, wherein the hierarchy of deposit sources includes, in order: a repayment by mail, if pre-authorized with the computer; a recurring direct deposit; a one-time deposit; and the one of the plurality of prepaid card accounts associated with the one of the plurality of line of credits.

7. Non-transitory computer-readable medium having computer program stored therein, the computer program comprising instructions that when executed by a computer associated with a financial institution perform the operations of:
establishing a plurality of line of credits associated with a plurality of prepaid card accounts with a financial institution responsive to historical direct deposit data, each of the plurality of line of credits having an adjustable line of credit limit,
determining a repayment schedule responsive to receiving a loan request for one of the plurality of line of credits, the repayment schedule further being responsive to direct deposit data for a customers associated with the one of the plurality of line of credits and preselected product parameters,
advancing funds to one of the plurality of prepaid card accounts associated with the one of the plurality of line of credits so that the funds are immediately available,
monitoring the one of the plurality of prepaid card accounts associated with the one of the plurality of line of credits for an expected direct deposit from a first duration prior to an expectation date for the expected direct deposit and up to a second duration after the expectation date for the expected direct deposit to thereby define a buffer around the expected direct deposit, and
obtaining a repayment pursuant to the repayment schedule according to a predetermined hierarchy of deposit sources, the predetermined hierarchy of deposit sources excluding preselected deposit sources.

8. Non-transitory computer-readable medium as defined in claim 7, wherein the operation of advancing funds thereby converts a prepaid card associated with the one of the plurality of prepaid card accounts into a loan delivery apparatus and so that the computer converts loan request data from the customer into a value associated with the prepaid card capable of purchasing goods and services.

9. Non-transitory computer-readable medium as defined in claim 7, wherein the adjustable line of credit limit corresponds to an amount between about 75 percent to about 150 percent of an average direct deposit amount.

10. Non-transitory computer-readable medium as defined in claim 7, wherein the repayment schedule includes two to four payments.

11. Non-transitory computer-readable medium as defined in claim 7, wherein the buffer around the expected direct deposit begins two days before the expected direct deposit and ends two days after the expected direct deposit so that the computer does not miss an early or late direct deposit.

12. Non-transitory computer-readable medium as defined in claim 7, wherein the hierarchy of deposit sources includes, in order: a repayment by mail, if pre-authorized with the computer; a recurring direct deposit; a one-time deposit; and the one of the plurality of prepaid card accounts associated with the one of the plurality of line of credits.

13. A computer-implemented method of providing a plurality of line of credits associated with a plurality of prepaid cards, the method comprising:
establishing, by a computer associated with a financial institution to define a financial institution computer, a plurality of line of credits associated with a plurality of prepaid card accounts with a financial institution responsive to historical direct deposit data, each of the plurality of line of credits having an adjustable line of credit limit,
determining, by the financial institution computer, a repayment schedule responsive to receiving a loan request for one of the plurality of line of credits, the repayment schedule further being responsive to direct deposit data for a customers associated with the one of the plurality of line of credits and preselected product parameters,
advancing, by the financial institution computer, funds to one of the plurality of prepaid card accounts associated with the one of the plurality of line of credits so that the funds are immediately available,
monitoring, by the financial institution computer, the one of the plurality of prepaid card accounts associated with the one of the plurality of line of credits for an expected direct deposit from a first duration prior to an expectation date for the expected direct deposit and up to a second duration after the expectation date for the expected direct deposit to thereby define a buffer around the expected direct deposit, and
obtaining, by the financial institution computer, a repayment pursuant to the repayment schedule according to a predetermined hierarchy of deposit sources, the predetermined hierarchy of deposit sources excluding preselected deposit sources.

14. A computer-implemented method as defined in claim 13, wherein the operation of advancing funds thereby converts a prepaid card associated with the one of the plurality of prepaid card accounts into a loan delivery apparatus and so that the computer converts loan request data from the customer into a value associated with the prepaid card capable of purchasing goods and services.

15. A computer-implemented method as defined in claim 13, wherein the adjustable line of credit limit corresponds to an amount between about 75 percent to about 150 percent of an average direct deposit amount.

16. A computer-implemented method as defined in claim 13, wherein the repayment schedule includes two to four payments.

17. A computer-implemented method as defined in claim 13, wherein the buffer around the expected direct deposit begins two days before the expected direct deposit and ends two days after the expected direct deposit so that the computer does not miss an early or late direct deposit.

18. A computer-implemented method as defined in claim 13, wherein the hierarchy of deposit sources includes, in order: a repayment by mail, if pre-authorized with the computer; a recurring direct deposit; a one-time deposit; and the one of the plurality of prepaid card accounts associated with the one of the plurality of line of credits.

19. A computer-implemented method as defined in claim 13, wherein the preselected product parameters require a minimum payment for all scheduled payments while there is an outstanding balance; and wherein the step of determining a repayment schedule further includes providing a minimum period before any repayment is due to separate the advancing of funds from a first scheduled repayment to thereby define a buffer zone for repayment.

20. A computer-implemented method as defined in claim 18, wherein the excluded preselected deposit sources include payments for child support; and wherein the one-time deposit includes one or more of the following: a bonus, a reimbursement, an in-store load, a tax return, and wherein the financial institution is a federally-chartered bank and the line of credit is bank product so that the line of credit complies with federal Regulation Z.
